(19) United States
(12) Patent Application Publication
(10) Pub. No.: US 2012/0173508 A1
(43) Pub. Date: Jul. 5, 2012

(54) Methods and Systems for a Semantic Search Engine for Finding, Aggregating and Providing Comments

(76) Inventor: Cheng Zhou, Yorktown Heights, NY (US)

(21) Appl. No.: 13/271,223

(22) Filed: Oct. 11, 2011

Related U.S. Application Data
(60) Provisional application No. 61/393,183, filed on Oct. 14, 2010.

(51) Int. Cl. G06F 17/30

(52) U.S. Cl. 707/709; 707/722; 707/E17.014; 707/E17.108; 707/E17.002

(57) ABSTRACT

One of the deficiencies of the existing search engines is that the search engines do not evaluate the trustfulness of comments before the searched comments are returned to end users. In addition, existing search engines overlook the analyzing and aggregating of the comments whose subjects are semantically, hierarchically related. Furthermore, as the use of non-textual comments has become popular nowadays, it is highly desirable that such search engines finding and providing comments have the capability to analyze, evaluate and aggregate both textual and non-textual comments, or heterogeneous comments in other words. The purpose of the invention is to overcome the abovementioned deficiencies of the existing search engines that find and provide comments.

### CLAIMING PRIORITY

THE INVENTOR CLAIMS THE PRIORITY TO THE PROVISIONAL PATENT, OF WHICH THE ESF ID IS 8628948, THE APPLICATION NUMBER IS 61/393,183, THE TITLE IS “METHODS AND SYSTEMS FOR A SEMANTIC SEARCH ENGINE FRAMEWORK FOR FINDING, AGGREGATING AND PROVIDING COMMENTS”, AND THE FILING DATE WAS Oct. 14, 2010.

### TECHNICAL HELD

The invention relates generally to search engines. More specifically, the invention relates to methods and systems for finding, aggregating and providing comments.

### BACKGROUND

Today, people use search engines to find comments on a product, service, event, person, company, or any other subjects. Intuitively, comments are not useful unless they are trustful. Most existing search engines (unless otherwise stated the terms “search engines” and “a search engine” as used herein refers to the search engines that find and provide comments), however, return to users only the URLs (Universal Resource Locators) that link to comments, leaving the verification tasks to users. A few other search engines place indicators, such as “verified buyer, next to associated comments. Given the improvement, it is still a deficiency, if not a defect, for the search engines to omit evaluating comments within the framework of a search engine.

It is worth mentioning that there is a value to provide similar and related comments. Consider this scenario: An ordinary consumer is looking at an Inspiron R laptop, and what likely come first to his mind is “is a Dell laptop a good one?” Lots of studies have stated that consumers recognize a brand before they start to think about a particular model of that brand. In that sense, the consumer may love to read comments on a Dell brand that is semantically (“Dell” to “Inspiron”) and hierarchically (“brand” to “model”) related to the Inspiron R laptop. Unfortunately, existing search engines do not analyze the semantic and hierarchical relations among comments.

In addition, comments in non-textual format have become popular these days. For example, emoticons and animated GIF (Graphics Interchange Format) images are widely used in forums, blogs, and emails to express writers' opinions. Some web sites, like cnet.com and tigerdirect.com, use videos for product reviews. From a user's perspective, these contents are visualized and easier to understand. Most importantly, they are part of the comments, and omitting them will result in incompleteness of information and compromise the judgment of end users. The reality is that existing search engines do not focus on non-textual contents, relate them to textual contents, and aggregate them for end users.

In summary, it is reasonable to conclude that evaluating comments is an intrinsic component of search engines that is built to find and provide comments. It is highly desirable that hierarchical and non-textual comments be automatically aggregated and provided by a search engine.

### SUMMARY

The embodiment disclosed herein includes a semantic search engine framework that includes intrinsic components to evaluate comments and to aggregate heterogeneous and hierarchically related comments.

As used in the specification, the term “comment” or “comments” refers to, but not limited to, a comment, review, opinion, remark, judgment, assessment, and statement with regard to a subject that is posted, cited, or quoted on a variety of digital media including web pages, PDF files, excel workbooks, and so on.

In addition, the term “comment” or “comments” shall mean to include textual and non-textual contents, hereafter referred as heterogeneous contents, unless otherwise specified. Furthermore, the term “comment” or “comments” is interchangeable with such words or phrases as “commentary data”, “commentary contents” and “contents of comments”.

As used in this invention, non-textual content refers to, but not limited to, static image, animated image, and any type of multi-media digital files.

As used in this invention, the term “a” or “an” generally refers a sort or group of objects sharing the same characters inferred by one specific object of the type or group.

### BRIEF DESCRIPTION OF THE FIGURES

FIG. 1 is the framework of existing search engines finding, aggregating and providing comments.

FIG. 1 is the framework of a semantic search engine introduced by this invention to find, aggregate and provide comments.

FIG. 3 shows the components of the crawler 200 in FIG. 2.

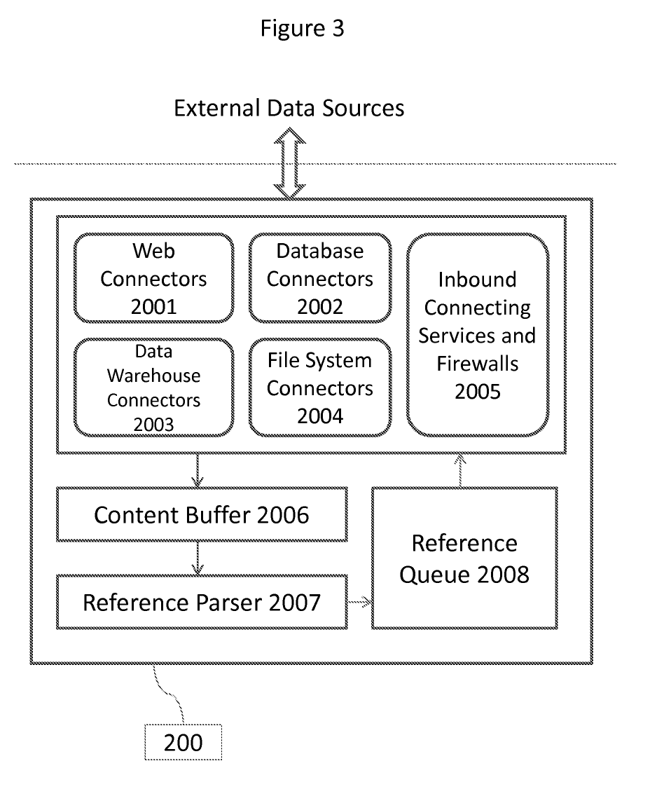

FIG. 4 shows the components and processes of the analyzer 201 in FIG. 2.

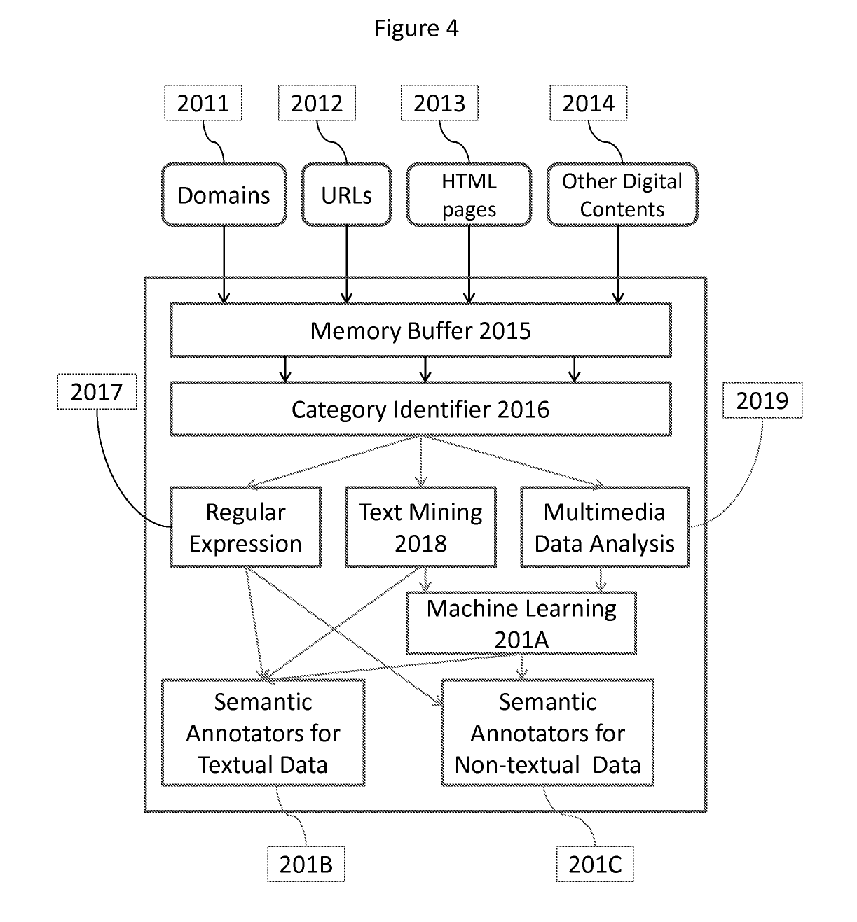

FIG. 5A shows the components of the evaluator 203 in FIG. 2.

FIG. 5B shows the components and processes of the evaluator for textual data 2031 in FIG. 5A.

FIG. 5C shows the components and processes of the evaluator for non-textual data 2032 in FIG. 5A.

FIG. 5D is the data profile 2034 that holds the metadata of a comment. It comprises a subject profile 20341 and a content profile 20342. The data profile 2034 can be used for heterogeneous comments. In the sense, the textual data profile 20311 in FIG. 5B and the non-textual data profile 20321 in FIG. 5C are typical examples of the data profile 2034.

FIG. 6 shows the components and processes of comment aggregation. Aggregation is performed on same-site, cross-site and hierarchical levels. Heterogeneous comments are also included.

FIG. 7 is the components of the indexer 205 in FIG. 2.

### COMPARISON AND INNOVATIONS

Existing Search Engines

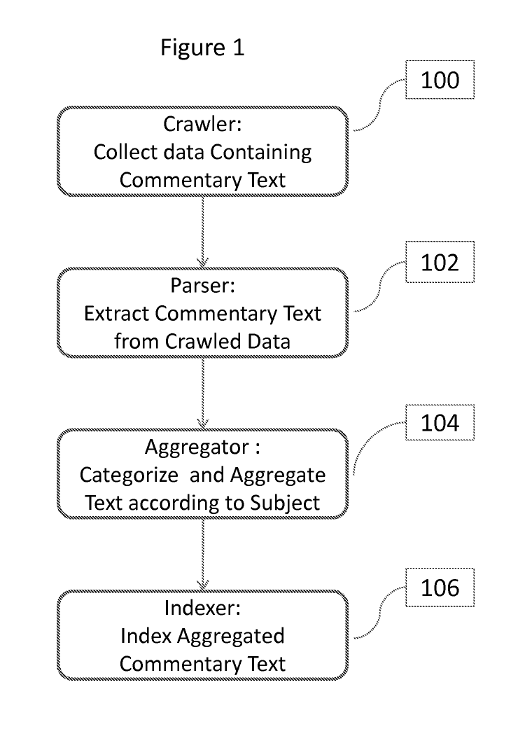

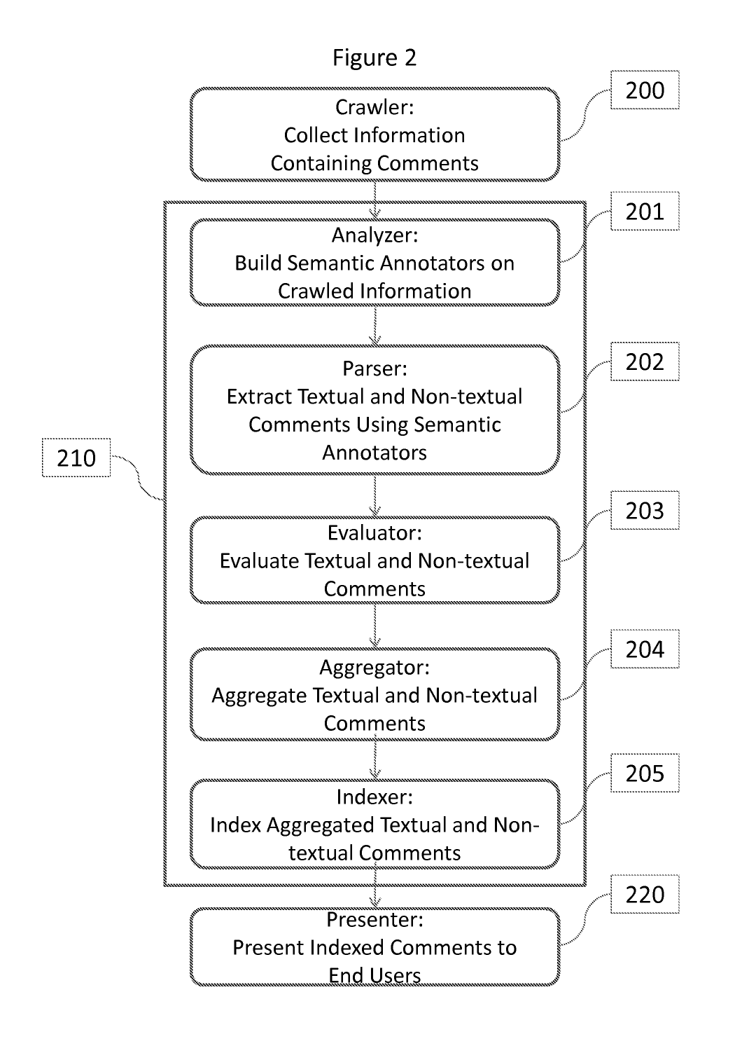

FIG. 1 is a block diagram illustrating the framework of a existing search engine finding, aggregating and providing comments. Similar to the framework of a general web search engine, like www.google.com, the framework in Figure I has a crawler 100, parser 102 and indexer 106. The major difference is that the latter framework has an aggregator 104, responsible for categorizing and aggregating textual comments.

Semantic Search Engines

FIG. 2 is a block diagram illustrating the framework of a semantic search engine finding, evaluating, aggregating and providing comments. The framework has three function blocks:

The first function block is a crawler module 200 delegated to one or more servers that are connected to not only Internet but also intranet, database, data warehouse and file systems. The crawler module 200 selectively collects data containing comments from the data sources. It also accepts connection requests and receive data containing comments from the data sources.

The second function block 210 comprises the following modules:
An analyzer model 201, which analyzes the crawled data and use the metadata of the data to build semantic annotators for the extraction of heterogeneous comments.
A parser module 202, which uses the semantic annotators created by the analyzer model 201 to extract textual comments from HTML pages, PDF files, Word documents, PowerPoint presentations, and other data media. The parser module also extracts non-textual data like picture, animation, music and video from the crawled data.
An evaluator module 203, which evaluates the heterogeneous comments extracted by the parser module 202 and performs sanity checks.
An aggregator module 204, which aggregates heterogeneous comments on same-site and cross-site levels, and on a hierarchical level as well.
An indexing module 205, which maps words, phrases and semantic annotators to the aggregated comments and the crawled data. The mapping information or indices are stored in an index warehouse accessible to end user queries.

The third function block is a presenter module 220, which processes end user queries, search the indices, and return matched results to end users.

Differences and Innovations

There are fundamental differences in the two types of search engines. The first type adds aggregation capability on top of a general search engine and claims that the revised search engine can effectively aggregate comments and serve end users. The inventor of the second type argues that aggregating comments is a semantics intensive assignment and thus a search engine without semantic analysis capability simply does not work.

The first type of search engines aggregates comments merely according to the subject, which in the opinions of the inventor is far from sufficient. For the benefits of end users and for the purpose of building a search engine aggregating comments, the capability to aggregate hierarchically related comments is a must.

The inventor further points out that handling heterogeneous comments is an intrinsic component to a search engine providing comments. Without it, the search engine overlooks the increasingly large amount of non-textual commentary data. Most importantly, it will surely fail to offer complete information, thereby compromising the judgment of end users.

### DETAILED DESCRIPTION OF THE INVENTION

The purpose of the invention is to overcome the deficiencies of the existing search engines. Essentially, the invention treats semantic analysis as an important capability of a search engine. Furthermore, the invention introduces a new search engine capable to work with heterogeneous and hierarchically related comments.

Crawling

The crawler module 200 connects to not just Internet but a variety of data sources through web connectors 2001, database connectors 2002, data warehouse connectors 2003, and file system connectors 2004. The term “connectors” refers to software or services that facilitate communication links among multiple parties. Besides, the crawler module 200 accepts inbound connection requests, which is managed by inbound connecting services and firewall 2005. The inbound connection capability ensures that timely sensitive comments be crawled promptly.

Through established connection, the data containing comments is fetched to a content buffer 2006, and then passed to a reference parser 2007, which extracts references from inputs. The term “reference” refers to the next fetching target. Examples of the references are the hyperlinks in an HTML page or the files in a directory.

The extracted references are stored in a reference queue 2008 till the next fetching cycle. They are scored in the queue to reflect their relative importance. The references with higher scores are fetched earlier, while duplicate or least important ones are filtered.

Building Semantic Annotators

Semantic annotators as used herein refer to a file, a program, or a data structure created by semantic analysis techniques such as ontology and machine learning. They are used to extract target information intelligently. A typical semantic annotator is an XML file that contains a key-value pair referring to a product name and the location of the product name in an EXCEL worksheet. Some more complex example is a JScript program that retrieves the hidden product price on an Amazon web page. Since semantic annotators are created for particular purposes and have been optimized by domain experts, they recognize not only keywords but also the underlying meaning of the target contents. With the aid of semantic annotators, a search engine can analyze semantics intensive human reviews.

Building semantic annotators involve multiple steps. The first is to determine the category of the crawled data using such inputs as domains 2011, URLs 2012, HTML pages 2013 and other contents 2014. The inputs, originally stored in a memory buffer 2015, are passed over to a category identifier 2016 for category identification. The identification is described below:
The category identifier 2016 searches domains 2011 or the domain inferred by the URLs 2012 against a list of key-value pairs whose key property refers to a domain name and value property refers to categories associated with that domain name. If a domain name is hit, the categories referred by the value property are used as the categories of the currently observed data. If no hit is found, the identification process moves to the next;
The category identifier 2016 searches the header of the HTML pages 2013 for certain tags like <title> and <description>, and for such outer HTML text as “Areas of interests: outdoor sports”. If no hit is found, the identification process moves to the next. Otherwise, the matched contents are screened against a group of predefined category keywords like “HTDV”, “Car” and “Sport”. The category identifier 2016 will jump to the next step if no match is found. Otherwise, the highest occurrence of the matched category keyword is used as the categories of the currently observed data.
The identifier module 2016 searches the contents 2014 for predefined category keywords, and counts the hits for each of the keywords. The top five hits are singled out, and each compared with a threshold set by some machine learning program. For those hit numbers exceeding the threshold, the associated keywords are used as the categories of the currently observed data. If none of the hits passes the threshold test or no hits at all, the currently observed data is given a NULL value as its category which results in a manual check.

After category is determined, the information is used to choose appropriate data analysis modules for building semantic annotators. Such modules include regular expression 2017, text mining 2018, multimedia data analysis 2019 and machine learning 201A. The building of semantic annotators involves three steps: (1) select factors that meaningfully describe a category. If “vehicle” is the category, for example, some of the factors can be “maker”, “year”, “model” and “number of air bags”, (2) identify content extraction programs for each of the factors. Take the factor of “year” as an example. The factor must have a value in a four-digit format, so a regular expression of “\{4}” and a text mining module 2018 that can executes the regular expressions are used to extract numbers of the format. (3) handle exceptions. Consider the factor one more time. Doesn't it look absurd to have car made in the year of 9999? Hence, an exception should be thrown out by the text mining module 2018 since 9999 is simply a wrong year for car making.

The examples above describe how to build a semantic annotator to extract the textual information. The steps to build semantic annotators for non-textual data extraction are similar except that a multimedia data analysis module 2019 is involved to analyze the data and handle the exceptions.

Parsing Contents

The processes of building semantic annotators takes into account data extraction already. In this sense, the tasks for the parser module 202 are to routinely check the collected data yet to parse, determine its multipurpose internet mail extensions (MIME), select and execute proper semantic annotators according to domain name, category and the MIME type. After the extraction, the parser module 202 stores the parsed contents in target locations and marks the data as “parsed”.

Evaluating Comments

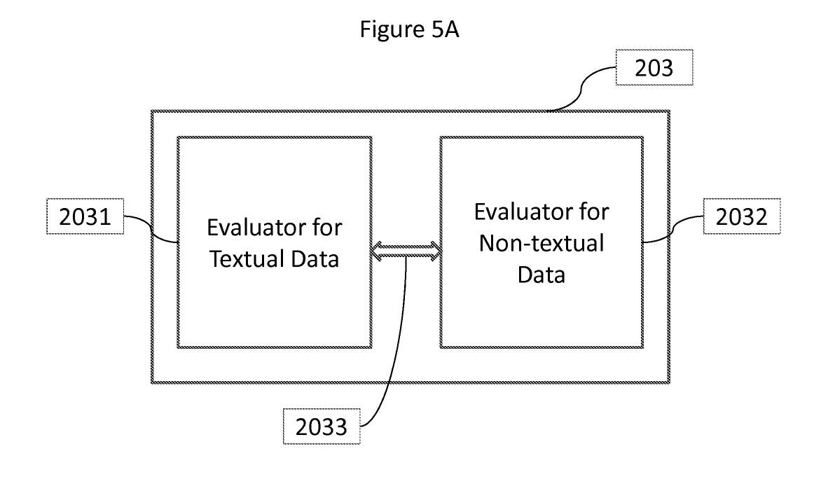

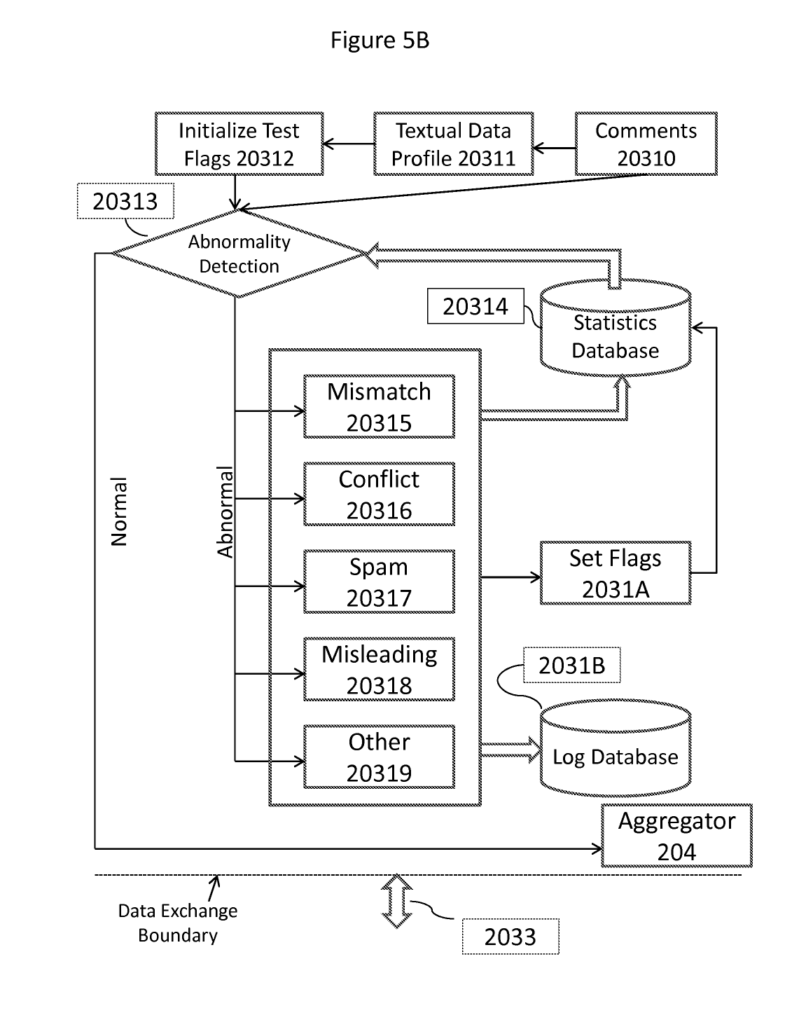

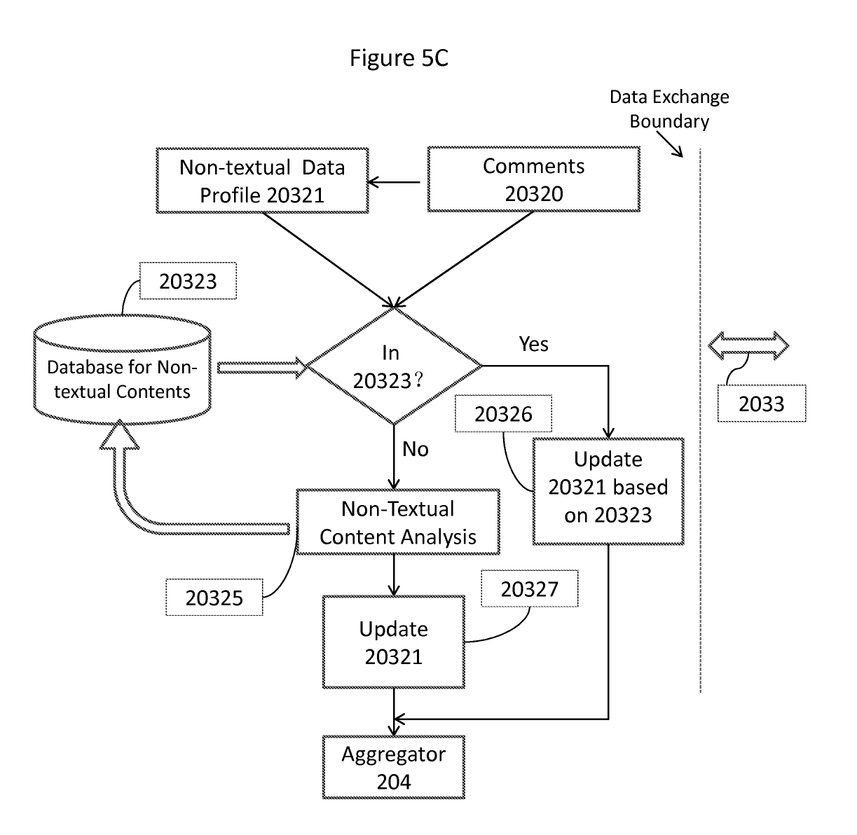

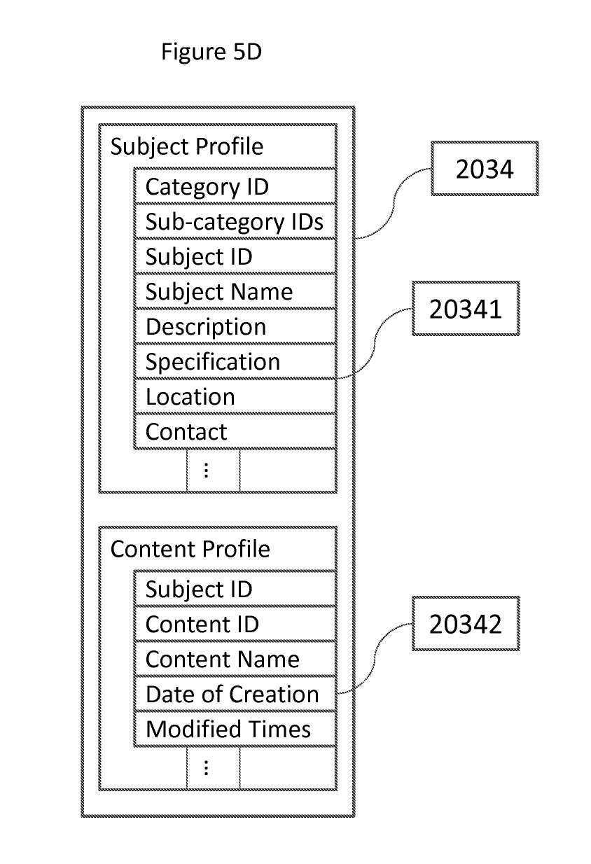

FIG. 5A is a diagram illustrating the components of an evaluator module 203. Of the two components in the module 203, one is the evaluator for textual data 2031 and the other is the evaluator for non-textual data 2032. The two components work together to make evaluation more productively. To understand why they work together, consider this case: a blog user left a one-word sentence “what?” followed by a few angry face emoticons. It is rather difficult to interpret the sentiment of the comments by just looking at the one-word sentence. However, a negative sentiment is easily detected if the evaluator 2032 recognizes the angry face emoticons and communicates it with the evaluator 2031. Likewise, there are many circumstances that the evaluator for textual data 2031 can help determine the underlying meaning of non-textual data.

FIG. 5B is a diagram illustrating the components and processes of the evaluator for textual data 2031. The evaluation starts with building textual dataprofiles 20311 on textual comments 20310. After the textual data profiles are built and test flags 20312 initialized, an abnormality detection module 20313 performs a sanity check comprising the following:
1) Mismatch (i.e. the comments indeed talk about a Toshiba laptop but the subject profile implies a bicycle);
2) Conflicting (i.e. the score shown in the content profile 20342 is top-notch but the commentary text contains more than normal negative adjectives):
3) Spam (i.e. the occurrence of a same username or same or similar commentary text exceeds a reasonable level for same or different subjects);
4) Misleading (i.e. a very few complains on the delivery speed of a product while thousands of yes' voted for the delivery service);
5) Lack of information (i.e. NULL value for category information, empty comment body, too many slangs);
If any abnormality is detected, the evaluator 2031 executes the following:
Store the abnormality in a statistic database 20314 where related statistical indicators, such as the occurrence of the abnormality for the currently evaluated subject, are updated;
Store the abnormality and the associated comments in a log database 2031B for further investigation;
Reset the test flags to the type of the abnormality and direct the evaluator 2031 to appropriate handling programs.

After the sanity check, the data profiles 20311 and the comments 20310 are marked as clean and passed to the aggregator module 204.

FIG. 5C is a diagram illustrating the components and processes of an evaluator for non-textual data 2032. The evaluation starts with building non-textual data profiles 20321 on non-textual comments 20320. If either the data file 20321 or the comments 20320 is in the database for non-textual content 20323, the matched record is returned and used to update the data file 20321.

If no hit is observed, the non-textual content analysis module 20325 starts to analyze the comments 20320 and extract the property information. Examples of property information include, but not limited to, file format, size, dimensions, resolution, pixel, ISO speed, author, creation time, last modified time, frame, and compression ratio. Following the extraction is an examination of the property information, which comprises verification of file format, video frame extraction, movement detection, video cutting and merging, correlation analysis, and so on. The analysis results are updated to the non-textual data profile 20321 as well as the database for non-textual content 20323.

After the analysis is completed, the data profiles 20321 and the comments 20320 are passed over to the aggregator module 204.

FIG. 5D illustrates a data profile 2034 which comprises a subject profile 20341 and a content profile 20342. The subject profile 20341 contains information describing the subject of a comment. Examples of the information arc source ID, category ID, subject ID and subject name. The content profile 20342 contains information describing the comments. Examples of the information are subject ID, content name, commenter's name and score.

Aggregating Comments

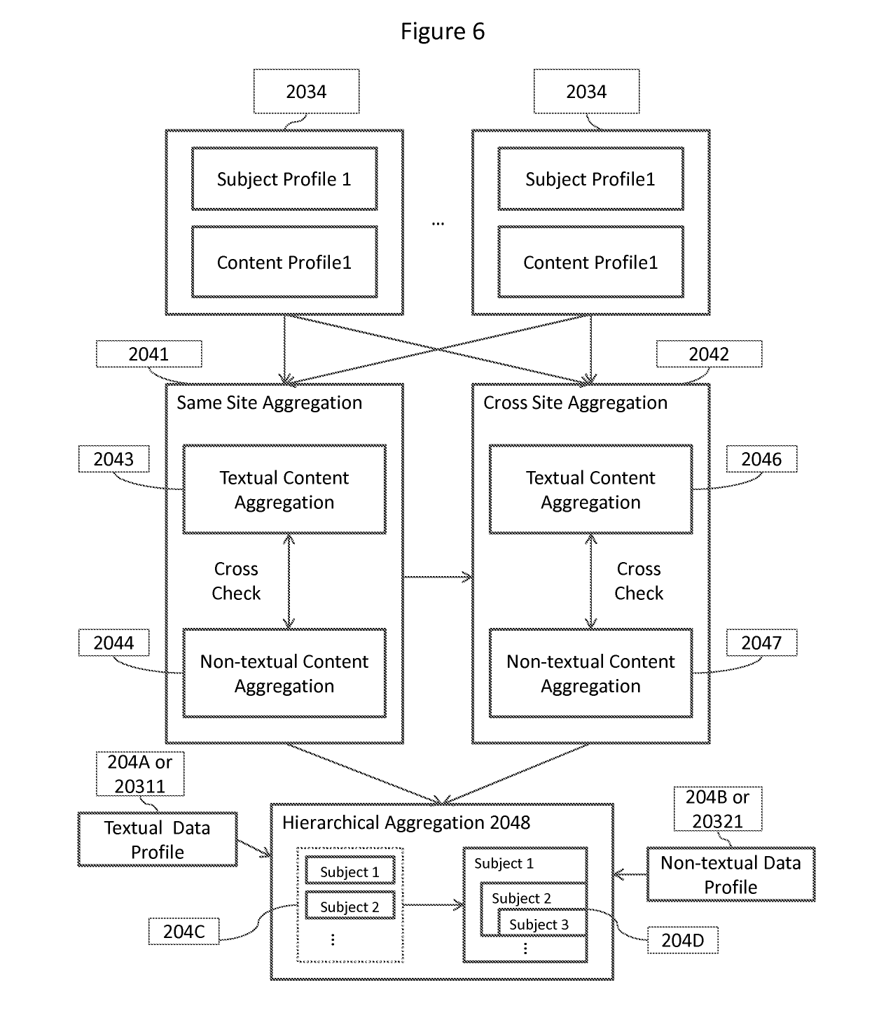

FIG. 6 illustrates an aggregator 204 that performs same-site aggregation 2041, cross-site aggregation 2042 and hierarchical aggregation 2048. The term “site” as used herein refers to data source.

It is worthy of noting that aggregation is not to combine comments, but summarize the comments to provide end users with meaningful information. The phrase “meaningful information” refers to, but not limited to, the overall sentiment, the variation of the sentiment by time, the popularity of a subject, and the value of a single comment. All the information can he inferred or implied by some statistical indicators. For example, the number of replies to the original post tells how popular the subject is. The overall sentiment can be calculated by setting up a numeric sentiment scale, using appropriate sentiment detection software to estimate the sentiment of each comment and map it to the scale, and then averaging all the sentiment numbers.

The same-site aggregation module 2041 compares multiple data profiles 2043 and determines if they share a same source ID and a same subject ID. If so, the data profiles are aggregated by proper content aggregation modules, i.e. the non-textual data profiles being aggregated by a non-textual content aggregation module 2044.

For textual comments, the textual content aggregation module 2043 first determines the statistical indicators to be affected given the aggregation. Then the module re-calculates the values associated with the indicators according to the predefined calculation guidance and stores the values in a new data file created for the currently observed subject. For non-textual comments, the aggregation module 2044 creates a new data profile for the currently observed subject and fills the statistical indicators with the aggregated sentiment values. After both new data profiles are updated, the aggregation module 2041 connects the two together through the subject ID.

The cross-site aggregation module 2042 compares two or more data profiles 2046 and determines if they have different source ID but same subject ID. If so, the aggregation is performed in a way similar to the same-site aggregation.

The hierarchical aggregation module 2048 compares two or more subject profiles 204C and determines if there exists inherent semantic relation between the subjects. For those subjects that arc related, the module 2048 will map the subjects to a multiple-layer tree structure in which the upper level nodes represent more general categories and the lower level nodes represent subcategories or models. Once the subjects 204D are organized in a tree structure, the task of the hierarchical aggregation is to ensure that the statistical indicators of the lower level nodes be reflected into those of the upper level nodes. For example, if a new Canon camera model receives 1,000 positive comments within an observed period, the total number of positive comments for the Canon brand increments by 1.000.

Indexing Comments

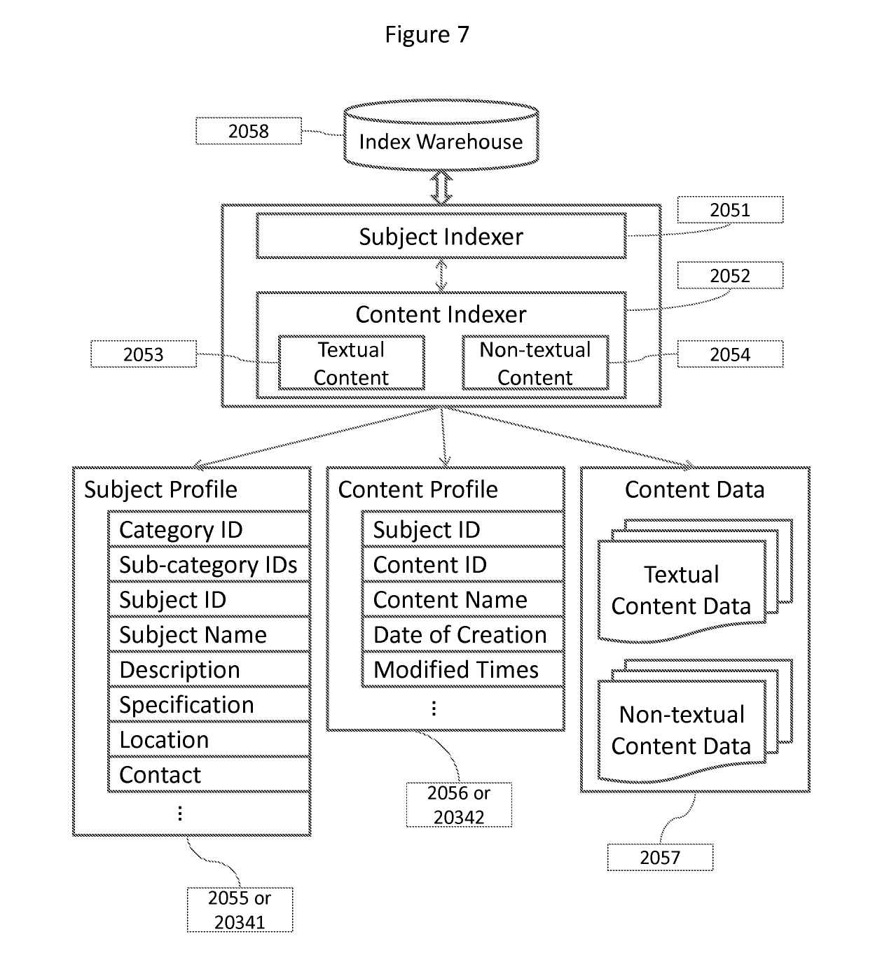

FIG. 7 shows the components of an indexer 205. The indexer 205 is comprised of a subject indexer 2051 and a content indexer 2052. There are two components in the content indexer 2052: a textual content indexer 2053 and a non-textual content indexer 2054.

The subject indexer 2051 maps words or phrases to the key-value pairs in the subject profiles 2055. The content indexer 2052 maps words or phrases to the key-value pairs in the content profiles 2056 and to the content data 2057. The subject indexer 2051 and the content index 2052 work together to ensure that the content profiles 2056 and the content data 2057 are returned if their subject profiles 2055 are hit by certain keywords. All the indices are stored an index warehouse 2058 for users' query.

Presenting Comments

A presenter module 220 receives user queries, rewrites the user queries, searches the indices in the index warehouse 2058, and returns matched results to end users. The query rewriting includes, but not limited to, the filtering of stop words and slangs, the detection of category keywords, and spelling check. The rewritten queries contain a limited number of words or phrases that are used to search the indices. The searching involves the search for subject profiles 2055 and the content profiles 2056 with the words or phrases after query rewriting. If one or more hits are found, both the matched subject profiles 2055 and the content profiles 2056 are returned and shown in either a web browser or a programmed GUI window in the user's computer.

What is claimed is:

1. A computer implemented method comprising: at one or multiple servers,
(1) Connecting to data sources providing comments:
(2) Collecting data containing comments from the data sources;
(3) Building semantic annotators on the collected data to extract comments;
(4) Using the semantic annotators to extract comments;
(5) Evaluating the comments;
(6) Aggregating the comments according to the subjects of the comments and the intrinsic semantic relations among the comments;
(7) Creating indices for the aggregated comments and the original comments;
(8) Processing user queries and presenting corresponding comments to users.

2. The computer-implemented method of claim 1, wherein the connecting comprises outbound connections to and inbound connections from data sources.

3. The computer-implemented method of claim 1, wherein data collecting comprises collecting textual and non-textual data, or heterogeneous data.

4. The computer-implemented method of claim 1, wherein the building semantic annotators comprises identifying the category information of the collected data and building semantic annotators for heterogeneous data.

5. The computer-implemented method of claim 1, wherein extracting comments comprises using semantic annotators to extract comments.

6. The computer-implemented method of claim 1, wherein evaluating comments comprises the use of semantic annotators and the filtering of comments. The types of filtering include, but not limited to, the following:
(A) Mismatch—the subject is X but the comment reads Y, and X is not Y;
(B) Conflict—the subject receives a top-notch review score from the commenter but the associated comments denounce the subject;
(C) Spam—the occurrence of same or similar comments exceeds a normal threshold at an observed period;
(D) Misleading—a comment without solid proofs contradicts the well-known facts:
(E) Lack of information—missing commenter information, empty commentary text, etc.

7. The computer-implemented method of claim 1, wherein aggregating comments comprises same-site, cross-site and hierarchical comment aggregation, as well as heterogeneous comment aggregation.

8. A search engine system that implements the methods of claim 1, wherein the system comprises a crawler module, analyzer module, parser module, evaluator module, aggregator module, indexer module, and a presenter module.

9. The search engine system of claim 8, wherein its processes comprise connecting, collecting, analyzing, parsing, evaluating, aggregating, indexing, and presenting.

10. The search engine system of claim 8, wherein the connecting comprises outbound connections to data sources providing comments and inbound connections from data sources providing comments.

11. The search engine system of claim 8, wherein the collecting comprises collecting heterogeneous data.

12. The search engine system of claim 8, wherein the analyzing comprises identifying the category information of the collected data and building semantic annotators for heterogeneous data.

13. The search engine system of claim 8, wherein the parsing comprises using semantic annotators to extract comments.

14. The search engine system of claim 8, wherein the evaluating comments comprises the use of semantic annotators. Besides, evaluating comments comprises filtering comments. The types of filtering include, but not limited to, the following:
(A) Mismatch—the subject is X but the comment reads Y, and X is not Y;
(B) Conflict—the subject receives a top-notch review score from the commenter but the associated comments denounce the subject;
(C) Spam—the occurrence of same or similar comments exceeds a normal threshold at an observed period;
(D) Misleading—a comment without solid proofs contradicts the well-known facts;
(E) Lack of information—missing commenter information, empty commentary text, etc.

15. The search engine system of claim 8, wherein the aggregating comprises same-site, cross-site and hierarchical aggregation. Besides, the aggregating comprises heterogeneous data aggregation.

16. The search engine system of claim 8, wherein the indexing comprises mapping words or phrases to both the aggregates comments and the original comments and storing the mapping information as indices.

17. The search engine system of claim 8, wherein the presenting comprises rewriting user queries into a limited number of words or phrases, searching indices for the aggregated and original comments containing the rewritten words or phrases, and returning the matched comments to end users.
